(19) United States
(12) Patent Application Publication
(10) Pub. No.: US 2004/0100758 A1
(43) Pub. Date: May 27, 2004

(54) Computer mainframe and display arrangement

(75) Inventors: Jan-Nan Chen, Kwei-Shan (TW); Ming-Hwa Chin, Kwei-Shan (TW)

Correspondence Address: TROXELL LAW OFFICE PLLC, SUITE 1404, 5205 LEESBURG PIKE, FALLS CHURCH, VA, 22041, US

(73) Assignee: Enlight Corporation

(21) Appl. No.: 10/304,752

(22) Filed: Nov. 27, 2002

(51) Int. Cl. G06F 1/16

(52) U.S. Cl. 361/681

(57) ABSTRACT

A computer mainframe and display arrangement is constructed to include a mainframe for personal computer, the mainframe having a locating slot in one recessed side panel thereof, and a display fastened pivotally with the mainframe, the display having a locating block fixedly provided at a back sidewall thereof, a coupling plate fastened pivotally with the locating block and forced into engagement with the locating slot of the mainframe to pivotally secure the display to the mainframe, and a foldaway stand pivoted to the locating block and adapted to support the display on the mainframe in a tilted position.

### BACKGROUND OF THE INVENTION

1. Field of the Invention

The present invention relates a mobile personal computer and, more specifically, to a computer mainframe and display arrangement, in which the display is fastened pivotally with the mainframe and, can be alternatively set in different positions relative to the mainframe.

2. Description of the Related Art

Following fast development of information automation technology, personal computer has become one of the requisite home appliances for data processing, information searching, communication, etc. Every computer supplier has been trying hard to create new utility models of computers to satisfy consumers' different requirements.

### SUMMARY OF THE INVENTION

The present invention has been accomplished under the circumstances in view. It is one object of the present invention to provide a computer mainframe and display arrangement, which enables the display (for example, LCD) to be detachably hung on the mainframe of the computer to same desktop space. It is another object of the present invention to provide a computer mainframe and display arrangement, which has its outer appearance shaped like a book that attracts consumers attention. To achieve these and other objects of the present invention, the computer mainframe and display arrangement comprises a mainframe, which has a locating slot in one recessed side panel thereof, and a display, which is fastened pivotally with the mainframe and has a foldaway stand for enabling the display to be supported on the mainframe in a tilted position.

### BRIEF DESCRIPTION OF THE DRAWINGS

FIG. 1 is an elevational view of a computer mainframe and display arrangement according to the present invention.

FIG. 2 is another elevational view of the computer mainframe and display arrangement when viewed from another angle.

FIG. 3 is an elevational view of the display according to the present invention.

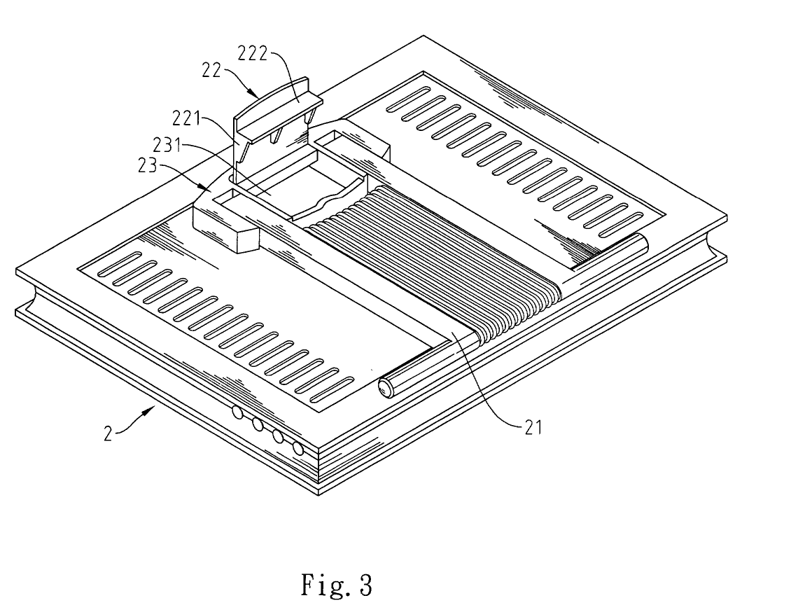

FIG. 4 is an exploded view of the present invention.

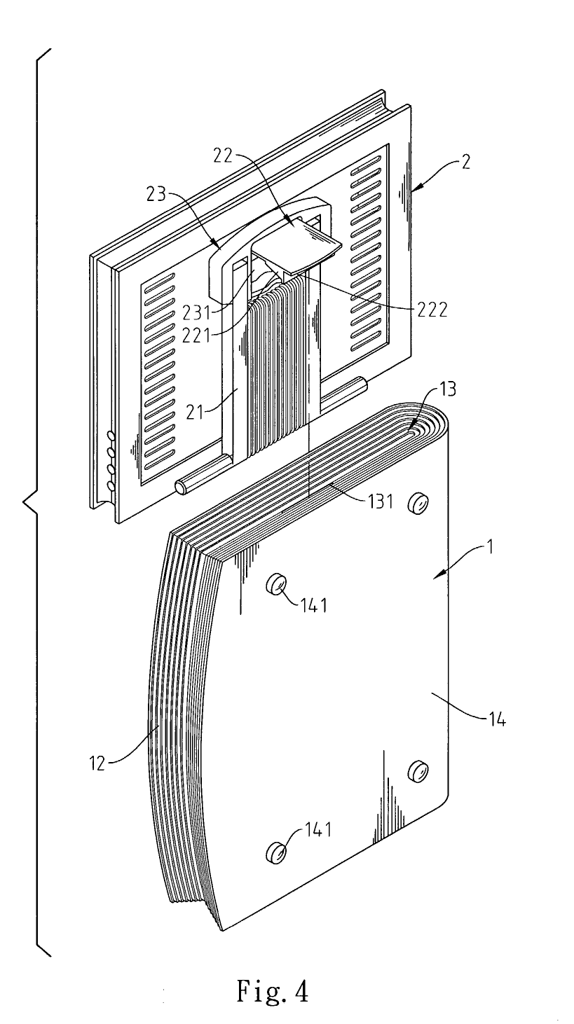

FIG. 5 is an elevational view of the mainframe according to the present invention.

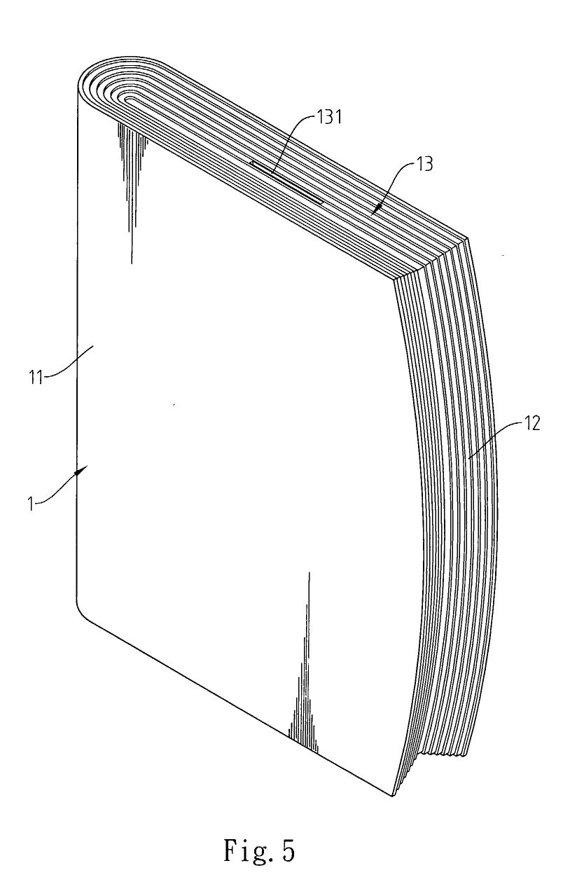

FIG. 6 illustrates the display supported on the mainframe in a tilted position according to the present invention.

### DETAILED DESCRIPTION OF THE PREFERRED EMBODIMENT

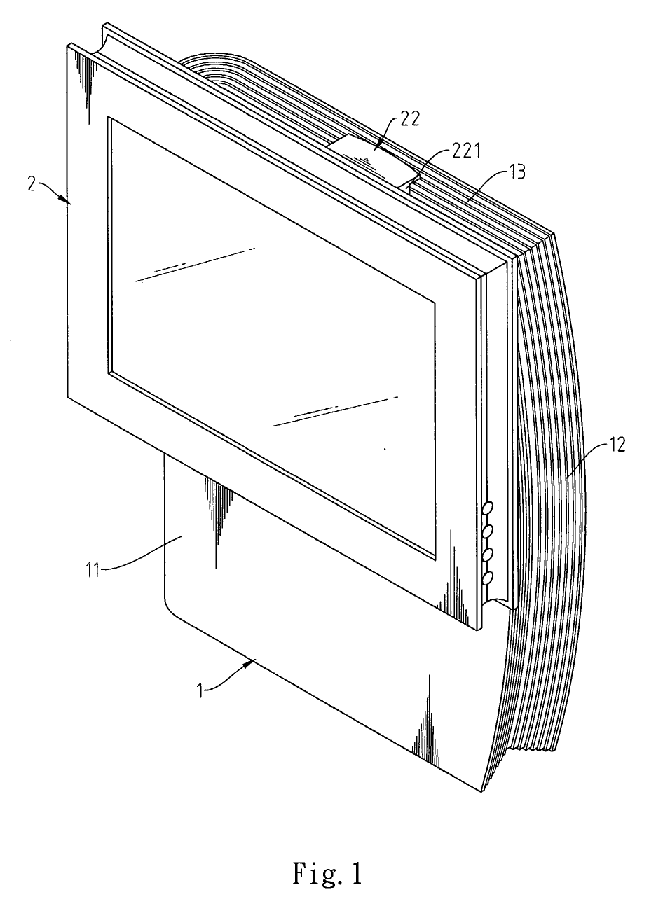

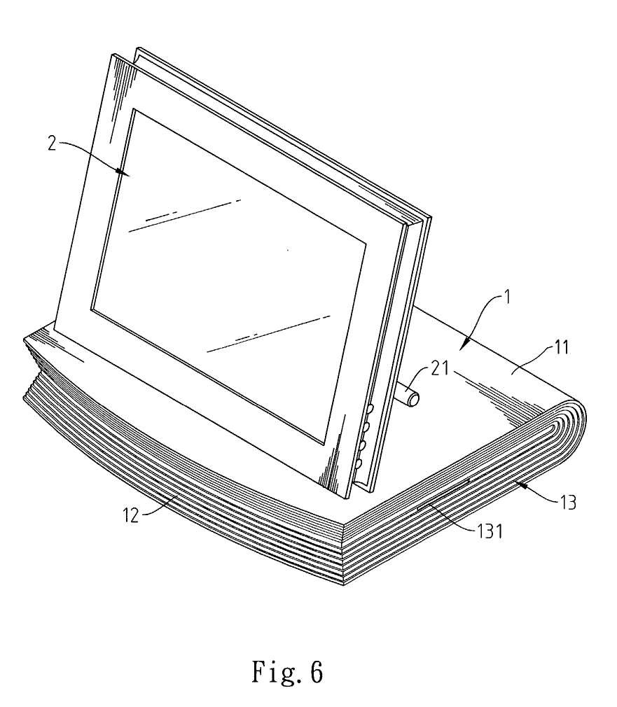

Referring to FIGS. 1 and 6, the invention is shown comprising a mainframe 1 and a display 2. The display 2 in accordance with the preferred embodiment of the present invention is a liquid crystal display fastened pivotally with the mainframe 1 such that the display 2 can alternatively be set closely attached to one side of the mainframe 1 as shown in FIG. 1, or in a tilt position above the mainframe 1 as shown in FIG. 6. The mainframe 1 and the display 2 have a respective compact, book-like outer appearance that attracts consumers' attention.

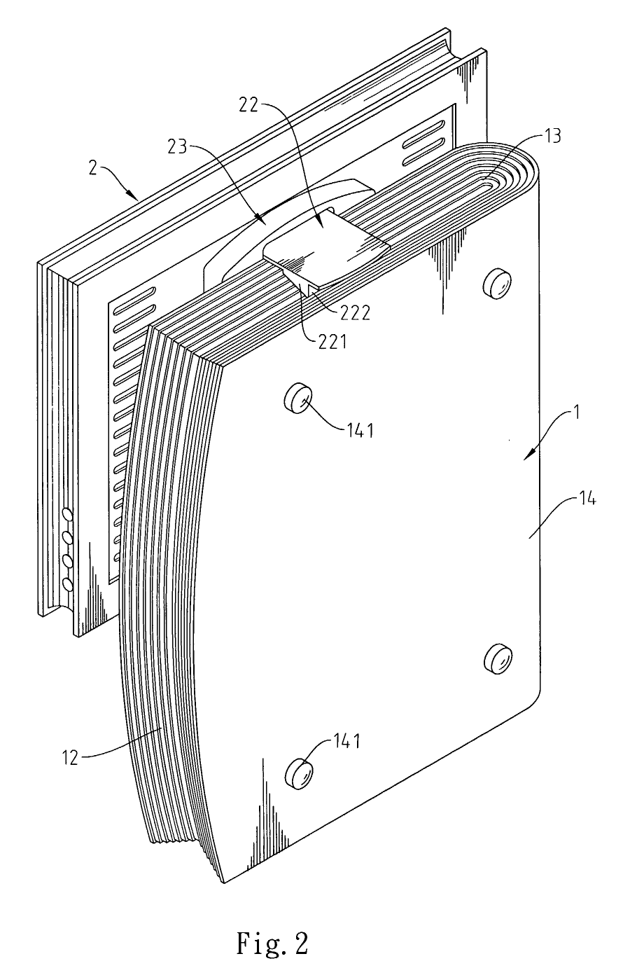

Referring to FIGS. 2˜5, the mainframe 1 is shaped like a book, having a top panel 11 adapted to support the display 2 or another implement, a bottom panel 14 opposite to the top panel 11, a plurality of foot pads 141 located on the bottom panel 14 and adapted to support the mainframe 1 stably on a flat surface, a recessed front panel 12 of substantially V-shaped cross section adapted to hold computer peripheral apparatus such as DVD player, disk drives, and etc., two recessed side panels 13 of substantially V-shaped cross section, and a locating slot 131 provided in one recessed side panel 13. The recessed front panel 12 and the recessed side panels 13 are grooved, showing the contour of the pages of a book.

The display 2 comprises a locating block 23 fixedly provided at the back sidewall thereof and defining a receiving open chamber 231, a foldaway stand 21 pivoted to the locating block 23, and a coupling plate 22 fastened pivotally with the locating block 23 and moved in and out of the receiving open chamber 231 of the locating block 23. The coupling plate 22 has a locating strip 222 and two retaining ribs 221 at two sides of the locating strip 222. When the mainframe 1 set in vertical with the locating slot 131 facing upwards, the locating strip 222 of the coupling plate 22 is engaged into the locating slot 131 and, at the same time the retaining ribs 221 are forced into friction-engagement with the corresponding recessed side panel 13 of the mainframe 1, keeping the display 2 pivotally secured to the mainframe 1.

A prototype of computer mainframe and display arrangement has been constructed with the features of FIGS. 1˜65. The computer mainframe and display arrangement functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A computer mainframe and display arrangement comprising a mainframe and a display fastened pivotally with said mainframe, wherein:
said mainframe has a locating slot in one recessed side panel thereof;
said display comprises a locating block fixedly provided at a back sidewall thereof, said locating block defining a receiving open chamber, a foldaway stand pivoted to said locating block and adapted to support said display on said mainframe in a tilt position, and a coupling plate fastened pivotally with said locating block and adapted to be moved in and out of said receiving open chamber, said coupling plate having a locating strip engaged into the locating slot of said mainframe, and two retaining ribs located on two sides of said locating strip and set into friction-engagement with the recessed side panel of said mainframe.
